(19) United States
(12) Patent Application Publication
(10) Pub. No.: US 2013/0004770 A1
(43) Pub. Date: Jan. 3, 2013

(54) MATERIALS COMPRISING A MATRIX AND PROCESS FOR PREPARING THEM

(75) Inventors: Gerhard Jozef Bleys, Heverlee (BE); Hans Godelieve Guido Verbeke, Lubbeek (BE)

(73) Assignee: Huntsman International LLC, The Woodlands, TX (US)

(21) Appl. No.: 13/522,338

(22) PCT Filed: Jan. 14, 2011
(86) PCT No.: PCT/EP2011/050425

§ 371 Date: Sep. 6, 2012

(30) Foreign Application Priority Data
Jan. 19, 2010 (EP) 10151054.3

(51) Int. Cl. C08L 75/04

(52) U.S. Cl. 428/402; 525/458

(57) ABSTRACT

The present invention is concerned with particulate material having a number average particle diameter of 1 μm-1 cm, exhibiting a solid-solid phase change, as measured by differential scanning calorimetry (DSC), in the temperature range −10° C. to +100° C. and comprising:
a matrix material comprising a plurality of urethane and/or urea and/or isocyanurate groups and having a hardblock content of more than 75% (hereinafter called matrix A); and
a polymeric material. Process for making this material and the use of it as.

The present invention relates to materials comprising a matrix comprising a plurality of urethane and/or urea and/or isocyanurate groups and having a hardblock content of more than 75%.

In a recent article by Harry Chen et al. presented at the CPI Technical Conference in Orlando, Fla., USA on 24-26 Sep. 2007 MDI semi-flexible foams having a very low density were made without polyols by reacting polyisocyanate and water in the presence of two non-reactive additives. The additives behave as plasticizers which soften the hard polymer matrix and provide flexibility to the foams. Chen does not disclose the chemical nature of the additives.

WO 2009/109600 discloses a foamed material comprising a matrix material, comprising a plurality of urea groups and having a hardblock content of more than 50%, and a polymeric material which 1) has no groups which are able to form a urethane, urea or isocyanurate group with an isocyanate group, 2) is interpenetrating said matrix and 3) is a polymer comprising at least 50% by weight of oxyethylene groups and having an average molecular weight of more than 500. No particulate material has been disclosed which has a solid-solid phase change in the temperature range −10° C. to +100° C. and no indication has been given how to make such a particulate material. The polymeric materials as used in said foamed material had either a melting point clearly below −20° C. or exhibited a phase change with an enthalpy ΔHₘ of well below 60 J/g.

In Thermochimica Acta 475 (2008) 15-21 Nihal Sarier and Emel Onder disclose PEG-containing polyurethane foams which have thermal insulation capability.

The isocyanate-reactive PEGs are impregnated into the polyurethane foam.

Qinghao Meng and Jinlian Hu disclose poly(ethylene glycol)-based phase change materials in “Solar Energy Materials and Solar Cells 92 (2008) 1260-1268”. They use isocyanate-reactive polyethylene glycols which are chemically bonded to polyisocyanates in order to make thermoplastic materials.

Surprisingly we have found that a matrix having a high hardblock content is suitable to make particulate material having very good properties allowing for damping of temperature cycles e.g. in buildings, clothing, transport containers and automotive interiors. The particulate material may be used as such or in composites to make such buildings, clothing, containers, interiors or parts thereof.

Therefore, the present invention is concerned with a particulate material having a number average particle diameter of 1 μm-1 cm, exhibiting a solid-solid phase change in the temperature range −10° C. to +100° C., as measured by differential scanning calorimetry (DSC), and comprising:
a matrix material comprising a plurality of urethane and/or urea and/or isocyanurate groups and having a hardblock content of more than 75% (hereinafter called matrix A); and
a polymeric material which 1) exhibits a phase change as measured by differential scanning calorimetry (DSC) in the temperature range −10° C. to +100° C., 2) forms a semi-interpenetrating network together with said matrix A, 3) has a number average molecular weight of more than 700 and 4) has no groups which are able to form a urethane, urea or isocyanurate group with an isocyanate group (hereinafter called polymeric material B); wherein the relative amount of said matrix A and of said polymeric material B, on a weight basis, ranges from 10:90 to 75:25.

Further the present invention relates to a process for preparing the above particulate material which process comprises reacting the ingredients for making the above matrix A in the presence of the above polymeric material B wherein the relative amount of the ingredients for making matrix A and of the above polymeric material B, on a weight basis, is such that the relative amount of the matrix A obtained and the polymeric material B ranges from 10:90 to 75:25 and producing a particulate material having an average particle diameter of 1 μm-1 cm and comprising said matrix A and material B.

Polymeric material B) is a so-called phase change material. Phase change materials and their use in polymeric materials are known.

In U.S. Pat. No. 4,825,939 polyethylene glycol or end-capped polyethylene glycol has been proposed as phase change material. The phase change material is incorporated in a polymeric composition by dissolving or dispersing it in the polymeric material in particular in polymers having a polar character like nylons, polyesters, acrylate rubbers and less polar ones like natural rubbers.

U.S. Pat. No. 4,111,189 shows dispersing phase change material in a polymeric material. Most preferred phase change material (PCM) is polyethylene glycol. The PCM should be immiscible in polymeric materials. A small amount of curing agent for liquid polymeric materials may be used together with additives like carbon black.

U.S. Pat. No. 6,765,031 discloses open cell foam composites comprising at least 80% volume of PCM. The PCM is imbibed into the open pores of the foam. Additives may be used. The foam may be a polyurethane foam.

Elsevier's Energy Conversion and Management 47 (2006) 3185-3191 discloses the use of polyurethane block copolymer made from polyethylene glycol (MW=10000), 4,4′-diphenylmethane diisocyanate and butanediol as phase change material.

Elsevier's Thermochimica Acta 475 (2008) 15-21 discloses polyurethane rigid foams wherein polyethylene glycol has been incorporated. Blends of polyethylene glycols have also been proposed. The PCM is impregnated into the rigid foam.

U.S. Pat. No. 5,106,520 discloses a powder-like mix of silica particles and a phase change material.

In U.S. Pat. No. 4,708,812 solid particulate phase change materials are encapsulated in a polymeric shell to provide heat storage materials.

WO 2006/077056 discloses coarse-particle microcapsules containing a microencapsulated phase change material device.

WO 2006/062610 discloses phase change material compositions comprising phase change materials and VLDPE, EPR, SEBS and/or SBS polymers.

The material according to the present invention is a so-called semi-interpenetrating network wherein the polymeric material B is interpenetrating matrix A and wherein polymeric material B can be considered as acting as a plasticizing material at elevated temperature, as a phase change material and as a so-called ‘heat sink’ when preparing matrix A at such high hardblock levels. In the process according to the present invention the polymeric material B is present during the preparation of matrix A, which ensures incorporation of polymeric material B into matrix A. The material according to the present invention can be used as a phase change material having a solid-solid phase change. Phase change materials having a solid-solid phase change have as such been disclosed; see US 2003/0124278, US 2004/0019123 and EP 914399.

In the context of the present invention the following terms have the following meaning:
1) isocyanate index or NCO index or index: the ratio of NCO-groups over isocyanate-reactive hydrogen atoms present in a formulation, given as a percentage:

$$\frac{[ NCO ] \times 100 ( \% )}{[ active hydrogen ]} .$$

In other words the NCO-index expresses the percentage of isocyanate actually used in a formulation with respect to the amount of isocyanate theoretically required for reacting with the amount of isocyanate-reactive hydrogen used in a formulation.
It should be observed that the isocyanate index as used herein is considered from the point of view of the actual polymerisation process preparing the material involving the isocyanate ingredient and the isocyanate-reactive ingredients. Any isocyanate groups consumed in a preliminary step to produce modified polyisocyanates (including such isocyanate-derivatives referred to in the art as prepolymers) or any active hydrogens consumed in a preliminary step (e.g. reacted with isocyanate to produce modified polyols or polyamines) are not taken into account in the calculation of the isocyanate index. Only the free isocyanate groups and the free isocyanate-reactive hydrogens (including those of water) present at the actual polymerisation stage are taken into account.
2) The expression “isocyanate-reactive hydrogen atoms” as used herein for the purpose of calculating the isocyanate index refers to the total of active hydrogen atoms in hydroxyl and amine groups present in the reactive compositions; this means that for the purpose of calculating the isocyanate index at the actual polymerisation process one hydroxyl group is considered to comprise one reactive hydrogen, one primary amine group is considered to comprise one reactive hydrogen and one water molecule is considered to comprise two active hydrogens.
3) Reaction system: a combination of components wherein the polyisocyanates are kept in one or more containers separate from the isocyanate-reactive components.
4) The term “average nominal hydroxyl functionality” (or in short “functionality”) is used herein to indicate the number average functionality (number of hydroxyl groups per molecule) of the polyol or polyol composition on the assumption that this is the number average functionality (number of active hydrogen atoms per molecule) of the initiator(s) used in their preparation although in practice it will often be somewhat less because of some terminal unsaturation.
5) The word “average” refers to number average unless indicated otherwise.
6) The term “hardblock content” refers to 100 times the ratio of the amount (in pbw) of polyisocyanate+isocyanate-reactive materials having a molecular weight of 500 or less (wherein polyols having a molecular weight of more than 500 incorporated in the polyisocyanates are not taken into account) over the amount (in pbw) of all polyisocyanate+all isocyanate-reactive materials used in making the matrix. In this calculation the amount of the polymeric material B used is not taken into account.
   The hardblock content of matrix A preferably is at least 75%, more preferably at least 90% and most preferably 100%.
7) Density: Is the overall density measured according to ISO 845.
8) ΔHₘ: Is the enthalpy of the phase change measured using a Mettler DSC 823 at a heating rate of 3° C./minute.
9) The average particle diameter in millimeter is defined as

$$2 \times \sqrt[3]{ } \frac{3 V}{4 π N} ,$$

wherein V is the total volume in mm³ of all particles and wherein N is the number of particles.

The polymeric material B is a material which has an average molecular weight of more than 700 and preferably of 800 to 20000 and more preferably of 800-12000. Further polymeric material B exhibits a phase change as measured by DSC in the temperature range of −10° C. to +100° C., preferably with an enthalpy ΔHₘ of at least 87, more preferably at least 90 and most preferably at least 100 J/g. Further this polymeric material preferably comprises at least 50% and preferably at least 75% by weight of oxyalkylene groups based on the weight of this polymeric material B wherein at least 85% and preferably at least 90% and most preferably 100% of the oxyalkylene groups are oxyethylene groups. If other oxyalkylene groups are present in polymeric material B they preferably are oxypropylene and/or oxybutylene groups and most preferably oxypropylene groups. Still further polymeric material B is a material which has no groups which are able to form a urethane, urea or isocyanurate group with an isocyanate group. Polymeric material B may consist of one particular polymer having all the above properties or it may be a mixture of polymers, the mixture having all these properties.

An example of a preferred polymeric material B is a dihydrocarbyl ether of a polyoxyethylene diol having a molecular weight of more than 700 and most preferably of 800-6000. The hydrocarbyl groups may be selected from acyclic and cyclic, linear and branched hydrocarbyl groups preferably having 1-8 and most preferably 1-6 carbon atoms. Examples of suitable hydrocarbyl groups are methyl, ethyl, propyl, butyl, hexyl, cyclohexyl and phenyl. The hydrocarbyl groups at the ends of polymeric material B may be the same or different. Polymeric materials B of this type are known and commercially available. Examples are polyglycol DME 1000 and 2000 which are the dimethyl ethers of a polyoxyethylene diol having an average molecular weight of about 1000 and 2000 respectively, both obtainable from Clariant.

An other example of a preferred material B is the reaction product of a polyisocyanate and a polyoxyalkylene monool and/or monoamine reacted at an index of 100-250.

The polyisocyanate for making this polymeric material B may be selected from aliphatic and, preferably, aromatic polyisocyanates. Preferred aliphatic polyisocyanates are hexamethylene diisocyanate, isophorone diisocyanate, methylene dicyclohexyl diisocyanate and cyclohexane diisocyanate and preferred aromatic polyisocyanates are toluene diisocyanate, naphthalene diisocyanate, tetramethylxylene diisocyanate, phenylene diisocyanate, tolidine diisocyanate and methylene diphenyl diisocyanate (MDI) and polyisocyanate compositions comprising methylene diphenyl diisocyanate (like so-called polymeric MDI, crude MDI, uretonimine modified MDI and prepolymers having free isocyanate groups made from MDI and polyisocyanates comprising MDI). MDI and polyisocyanate compositions comprising MDI are most preferred and especially those from 1) a diphenylmethane diisocyanate comprising at least 35%, preferably at least 60% and most preferably at least 85% by weight of 4,4′-diphenylmethane diisocyanate (4,4′-MDI); 2) a carbodiimide and/or uretonimine modified variant of polyisocyanate 1), the variant having an NCO value of 20% by weight or more; 3) a urethane modified variant of polyisocyanate 1), the variant having an NCO value of 20% by weight or more and being the reaction product of an excess of polyisocyanate 1) and of a polyol having an average nominal hydroxyl functionality of 2-4 and an average molecular weight of at most 1000; 4) a diphenylmethane diisocyanate comprising homologues comprising 3 or more isocyanate groups; and 5) mixtures of any of the aforementioned polyisocyanates. Polyisocyanates 1) and 2) and mixtures thereof are most preferred.

Polyisocyanate 1) comprises at least 35% by weight of 4,4′-MDI. Such polyisocyanates are known in the art and include pure 4,4′-MDI and isomeric mixtures of 4,4′-MDI and up to 60% by weight of 2,4′-MDI and 2,2′-MDI. It is to be noted that the amount of 2,2′-MDI in the isomeric mixtures is rather at an impurity level and in general will not exceed 2% by weight, the remainder being 4,4′-MDI and 2,4′-MDI. Polyisocyanates as these are known in the art and commercially available; for example Suprasec® MPR and 1306 ex Huntsman (Suprasec is a trademark of the Huntsman Corporation or an affiliate thereof which has been registered in one or more but not all countries).

The carbodiimide and/or uretonimine modified variants of the above polyisocyanate 1) are also known in the art and commercially available; e.g. Suprasec® 2020, ex Huntsman. Urethane modified variants of the above polyisocyanate 1) are also known in the art, see e.g. The ICI Polyurethanes Book by G. Woods 1990, 2″ edition, pages 32-35. Polyisocyanate 4) is also widely known and commercially available. These polyisocyanates are often called crude MDI or polymeric MDI. Examples are Suprasec® 2185 and Suprasec® DNR ex Huntsman.

Mixtures of the aforementioned polyisocyanates may be used as well, see e.g. The ICI Polyurethanes Book by G. Woods 1990, 2″ edition pages 32-35. An example of such a commercially available polyisocyanate is Suprasec® 2021 ex Huntsman Polyurethanes.

The polyoxyalkylene monool and/or monoamine is selected in such a way that the polymeric material B finally obtained meets the requirements as to molecular weight, oxyalkylene and oxyethylene content. Suitable polymers are known and commercially available. Examples are Jeffamine XTJ-418 ex Huntsman, a polyoxyalkylene monoamine having a molecular weight of about 2000 and an oxypropylene/oxyethylene group ratio of about 4/41 (Jeffamine is a trademark of Huntsman Corporation or an affiliate thereof which has been registered in one or more but not all countries) and the monomethylethers of polyoxyethylene diols having a molecular weight of about 1000 and 2000 ex Clariant. The molecular weight of these polymers is selected in such a way that the molecular weight of polymeric material B is within the previously described ranges, keeping also the molecular weight of the used polyisocyanate in mind A mixture of polymers having a different molecular weight may be used in order to obtain a polymeric material B with polymers having a different molecular weight. This allows for controlling the phase change temperature and ΔHₘ depending on the desired end use.

The relative amounts of the polyisocyanate and the polymer having one isocyanate-reactive group for making this type of polymeric material B may vary in such a way that the index is 100-250, preferably 100-150 and most preferably 100-110. This polymeric material B may be prepared by combining and mixing the polyisocyanate and the polymer and allowing the mixture to react. These reactions are exothermic and do not need heating or catalysis although catalysts may be used, heat may be applied (e.g. up to 150° C.) and the MDI may be added at elevated temperature in order to ensure liquidity. After the reacting mixture has cooled back to room temperature, the reaction may be regarded as complete. No other reactants are used in preparing this type of polymeric material B.

Matrix A is prepared in the presence of polymeric material B. Matrix A is prepared by reacting a polyisocyanate with an isocyanate-reactive compound having at least 2 isocyanate-reactive hydrogen atoms selected from water, hydroxyl and amine groups and/or by allowing the polyisocyanate to trimerize using a trimerization catalyst. These reactions are conducted in the presence of polymeric material B.

In making matrix A, the polyisocyanates may be selected from aliphatic and, preferably, aromatic polyisocyanates and mixtures of such polyisocyanates. Preferred aliphatic polyisocyanates are hexamethylene diisocyanate, isophorone diisocyanate, methylene dicyclohexyl diisocyanate and cyclohexane diisocyanate and preferred aromatic polyisocyanates are toluene diisocyanate, naphthalene diisocyanate, tetramethylxylene diisocyanate, phenylene diisocyanate, tolidine diisocyanate and methylene diphenyl diisocyanate (MDI) and polyisocyanate compositions comprising methylene diphenyl diisocyanate (like so-called polymeric MDI, crude MDI, uretonimine modified MDI and prepolymers having free isocyanate groups made from MDI and polyisocyanates comprising MDI). MDI and polyisocyanate compositions comprising MDI are more preferred. Polyisocyanates 1)-5), described before, are most preferred and in particular polyisocyanate 4).

Isocyanate-reactive materials having a molecular weight of more than 500, when used in making matrix A, may be selected from polyester polyols, polyether polyols, polyether polyester polyols, polyester polyamines, polyester polyether polyamines and polyether polyamines. Preferably these isocyanate-reactive materials have an average molecular weight of more than 500-10,000 and an average nominal functionality of 2-6.

Such materials have been widely described in the art and are commercially available.

Isocyanate-reactive materials having a molecular weight of at most 500, when used in making matrix A, may be selected from water and/or the chain extenders and cross-linkers commonly used in making elastomers of this type like ethylene glycol, polyethylene glycol having an average molecular weight of at most 500, 2-methyl-1,3-propanediol, neopentylglycol, propanediol, butanediol, pentanediol, hexanediol, ethylene diamine, toluene diamine, ethanolamine, diethanolamine, triethanolamine, propylene glycol, polypropylene glycol having an average molecular weight of at most 500, glycerol, trimethylolpropane, sucrose and sorbitol and mixtures thereof.

Any compound that catalyses the isocyanate trimerization reaction (isocyanurate-formation) can be used as trimerization catalyst in the process according to the present invention, such as tetraalkylammonium hydroxides (e.g. tetramethylammonium hydroxide, tetraethylammonium hydroxide and tetrabutylammonium hydroxide), organic weak acid salts (e.g. tetramethylammonium acetate, tetraethylammonium acetate, tetrabutylammonium acetate), trimethylhdyroxypropylammonium acetate, -octoate and -formate, trimethylhydroxyethylammonium acetate, triethylhydroxypropylammonium acetate and triethylhydroxyethylammonium acetate, trialkylhydroxyalkylammonium hydroxides (e.g. trimethylhydroxypropylammonium hydroxide, trimethylhydroxyethylammonium hydroxide, triethylhydroxypropylammonium hydroxide and triethylhydroxyethylammonium hydroxide), tertiary amines e.g. triethylamine, triethylenediamine, 1,5-diazabicyclo[4.3.0]nonene-5,1,8-diazabicyclo[5.4.0]-undecene-7 and 2,4,6-tris (dimethylaminomethyl)phenol and metal salts of alkylcarboxylic acids having 1-12 carbon atoms like alkali metal salts of such carboxylic acids (preferred alkali metals are potassium and sodium, and preferred carboxylic acids are acetic acid, hexanoic acid, octanoic acid, lactic acid and 2-ethylhexanoic acid; most preferred metal salt trimerization catalysts are potassium acetate (commercially available as Polycat 46 from Air Products and Catalyst LB from Huntsman) and potassium 2-ethylhexanoate (commercially available as Dabco K15 from Air Products). Two or more different trimerization catalysts may be used in the process of the present invention.

If used, the trimerization catalyst is used in an amount of up to 3% by weight based on the weight of the polyisocyanate used in making matrix A and preferably up to 1% by weight.

In order to ensure that the hardblock content of matrix A is more than 75%, the amount of polyisocyanates and isocyanate-reactive ingredients used in making matrix A and having a molecular weight of 500 or less and a molecular weight of more than 500 are chosen in such a way that the hardblock content of the materials is more than 75% as defined hereinbefore. Preferably the hardblock content is at least 90% and most preferably 100%.

Matrix A may be foamed or non-foamed. In making this foamed matrix A blowing agents are used which may be selected from inert blowing agents and reactive blowing agents. Examples of inert blowing agents are alkanes, hydrofluorocarbons, hydrochlorofluorocarbons, expandable microbeads and inert gases like air, N₂, CO₂, CO, O₂ and He and examples of reactive blowing agents are azodicarbonamide and water. Combinations and/or mixtures of these blowing agents may be used as well. Water is the most preferred blowing agent. The amount of blowing agent used may vary widely and depends primarily on the density desired.

The relative amounts of isocyanate-reactive ingredients and polyisocyanates used in making matrix A may vary widely. In general, the index will be at least 5.

In addition to the above ingredients, other ingredients commonly used in the art for making such materials comprising a plurality of urethane, urea and/or isocyanurate groups may be used like other catalysts, e.g. for enhancing urethane formation, surfactants, fire retardants, colourants, pigments, anti-microbial agents, fillers, internal mould release agents, cell-stabilizing agents and cell-opening agents.

In preparing matrix A in the presence of polymeric material B, polymeric material B may be added to the reaction mixture independently or after having been premixed with one or more of the ingredients used to make matrix A.

This provides a further advantage in preparing such materials. On an industrial scale such materials are often made by feeding separate streams of polyisocyanate, polyol and/or polyamine and/or trimerization catalyst and/or further ingredients to a mixer and/or a reactor. Since the polymeric material B may be combined with all of these streams, stream ratios may be controlled, improving mixing properties and rheology during production.

In making matrix A one or more of the following reactions take place: reaction of polyisocyanates and polyols giving polyurethanes, reaction of polyisocyanates and polyamines giving polyureas, reaction of polyisocyanates and water giving CO₂ and polyureas and trimerization of polyisocyanates giving polyisocyanurates.

The reaction of the polyisocyanates and the polyols is exothermic and may be conducted under ambient conditions. If desired the reaction may be enhanced by using a catalyst which stimulates urethane formation and/or by applying an increased temperature, e.g. 30-80° C.

The reaction of the polyisocyanates with the polyamines and/or the water is strongly exothermic and does not require heating or catalysis, although the polyisocyanates may be supplied at slightly increased temperature (e.g. up to 50° C.) to ensure liquidity and although heat and/or catalysis may be applied, if desired.

The trimerization reaction requires the use of a trimerization catalyst. When trimerization is the only reaction, preferably heat is supplied in order to ensure a temperature of 50-100° C. If one of the other reactions takes place, only a trimerization catalyst is needed. The exotherm of the other reaction ensures that trimerization takes place.

The reactions for preparing matrix A in general will go to completion between 1 minute and 2 hours and preferably between 1 minute and 1 hour.

The reaction for preparing matrix A may be conducted according to the one shot process, the semi-prepolymer process and the prepolymer process. The reaction may be conducted in an open container, in an open or closed mould or as a—continuous or batch block—slabstock process.

The material obtained, comprising said matrix A and polymeric material B and together called material C, is a so-called semi-interpenetrating polymer network wherein the polymeric material B penetrates on a molecular scale the polymer network which is matrix A (see IUPAC Compendium of Chemical Terminology, 2^{nd} Edition, 1997).

Producing the particulate material having an average particle diameter of 1 um-1 cm may be conducted by stirring the reacting mixture and/or by reducing the size of the material C.

Stirring the reacting mixture may be conducted in any known way using mixers, blenders, extruders and other known mixing devices.

Material C may be reduced in size in any known way, like by cutting, grinding, pellitizing, tearing, pulverizing, crushing, crumbling, granulating, milling and combinations thereof until particulate material is obtained having an average particle diameter of 1 μm-1 cm and preferably of 10 μm-5 mm and most preferably of 0.1-4 mm. This size reduction process preferably is conducted under ambient or cryogenic conditions for 1 minute to 8 hours and preferably for 2 minutes to 2 hours.

The material according to the present invention may be used as phase change material having a solid-solid phase transition in other materials like in bricks, mortars, glues, cements, grouts, coatings, sealants, plasterboard, gypsum, wood-panels, other building units for making houses and other buildings and in composite materials for providing phase change properties to such materials and in transport containers.

The material according to the present invention preferably comprises a matrix A which is a thermosetting material. Such a thermosetting matrix material is made by reacting the polyisocyanate and the isocyanate-reactive ingredients used for preparing matrix A while ensuring that at least one of the two has an average functionality of more than 2.1 in order to provide cross-linking. If a polyisocyanurate matrix is made there will be sufficient crosslinking because of the formation of the isocyanurate groups; such materials are also thermosetting if a diisocyanate is used.

The invention is illustrated with the following examples.

The following ingredients were used:
Monomethylether of polyoxyethylene diol having a MW of about 2000; hereinafter MoPEG2000.
Polyglycol DME 1000: dimethylether of a polyoxyethylenediol having a molecular weight of about 1000; hereinafter DME 1000.
Polyglycol DME 2000: dimethylether of a polyoxyethylenediol having a molecular weight of about 2000; hereinafter DME 2000.
Suprasec 1306 and Suprasec 2185 were used as polyisocyanates.

Tₘ=melt temperature (in ° C.).

### EXAMPLE 1

### Preparation of Polymeric Material B

Polymeric material B 1 was made as follows. The monofunctional ingredient was put in a 5 liter flask recipient equipped with a stirrer, thermocouple and nitrogen purge. Polyisocyanate was added slowly under stirring (Suprasec 1306 was preheated at 50° C.). The reaction mixture was heated to 80° C.

The phase change properties were measured using Mettler DSC 823 equipment at a heating rate of 3° C./minute.

Further information is given in Table 1.

TABLE 1

| | Mono- | | | | |
|---|---|---|---|---|---|
| Polymeric | functional | Polyiso- | MW of | | |
| material | ingredient | cyanate | polymeric | | ΔHₘ |
| B | used | used | material B | Tₘ, ° C. | (J/g) |
| 1 | MoPEG 2000 | Suprasec 1306 | 4250 | 50.9 | 117.8 |
| 2 | DME 1000 | — | 1000 | 36.6 | 136.0 |
| 3 | DME 2000 | — | 2000 | 51.4 | 151.4 |

### EXAMPLE 2

Particulate materials were prepared by blending the polymeric material B at ±50° C. with water. This blend was allowed to cool down to ±35° C. and under stirring an amount of Suprasec 2185 was added and the mixture was comminuted by stirring for another 5 minutes. The particulate material obtained was placed in an oven at 60° C. for 2 hours for removing the unreacted water.

The particulate material obtained had an average particle diameter between 1 μm and 1 cm. In Table 2 the amounts of ingredients are given.

TABLE 2

| | | Amount of water | Weight |
|---|---|---|---|
| | | (pbw on 100 pbw | ratio of |
| | Polymeric | polymeric | isocyanate: |
| Particulate | material | material | polymeric |
| material | B used | B + isocyanate | material B |
| 1 | 1 | 30 | 1:3 |
| 2 | 2 | 25 | 1:3 |
| 3 | 3 | 20 | 1:3 |

The phase change properties of the particulate materials were measured using Mettler DSC 823 equipment at a heating rate of 3° C./minute. The results are given in Table 3. The particulate materials 1, 2 and 3 had a solid-solid phase change in the temperature range −10° C. to +100° C.

TABLE 3

| Particulate material | Tₘ, ° C. | ΔHₘ (J/g) |
|---|---|---|
| 1 | 49 | 65 |
| 2 | 34.5 | 54.9 |
| 3 | 50 | 75.4 |

1. A particulate material having a number average particle diameter of 1 μm-1 cm, exhibiting a solid-solid phase change in the temperature range −10° C. to +100° C., as measured by differential scanning calorimetry (DSC), and comprising:
a matrix material comprising a plurality of urethane and/or urea and/or isocyanurate groups and having a hardblock content of more than 75% (hereinafter called matrix A); and
a polymeric material which 1) exhibits a phase change as measured by differential scanning calorimetry (DSC) in the temperature range −10° C. to +100° C., 2) forms a semi-interpenetrating network together with said matrix A, 3) has a number average molecular weight of more than 700 and 4) has no groups which are able to form a urethane, urea or isocyanurate group with an isocyanate group (hereinafter called polymeric material B); wherein the relative amount of said matrix A and of said polymeric material B, on a weight basis, ranges from 10:90 to 75:25.

2. Material according to claim 1 wherein the hardblock content in matrix A is at least 90%.

3. Material according to claim 1 wherein polymeric material B comprises at least 50% by weight, based on the weight of this polymeric material B, of oxyalkylene groups, wherein at least 85% of these oxyalkylene groups are oxyethylene groups.

4. Material according to claim 1 wherein polymeric material B exhibits a phase change with an enthalpy ΔHₘ of at least 87 J/g.

5. Material according to claim 4 wherein ΔHₘ is at least 90 J/g.

6. Process for preparing a material according to claim 1 which process comprises reacting the ingredients for making matrix A in the presence of polymeric material B wherein the relative amount of the ingredients for making matrix A and of polymeric material B, on a weight basis, is such that the relative amount of the matrix A obtained and the polymeric material B ranges from 10:90 to 75:25 and producing a particulate material having a number average diameter of 1 μm-1 cm and comprising said matrix A and material B.
